(19) United States
(12) Patent Application Publication
(10) Pub. No.: US 2008/0216178 A1
(43) Pub. Date: Sep. 4, 2008

(54) METHOD OF ACCESSING MULTIMEDIA CONTENT IN ACCORDANCE WITH INFORMATION OF A RECORDING MEDIUM

(75) Inventor: Frederic Herledan, Meylan (FR)

Correspondence Address: OBLON, SPIVAK, MCCLELLAND MAIER & NEUSTADT, P.C., 1940 DUKE STREET, ALEXANDRIA, VA, 22314, US

(73) Assignee: FRANCE TELECOM, PARIS (FR)

(21) Appl. No.: 12/032,415

(22) Filed: Feb. 15, 2008

Related U.S. Application Data
(62) Division of application No. 10/258,609, filed on Nov. 5, 2002, now abandoned.

(30) Foreign Application Priority Data
May 16, 2000 (FR) 00/06206

(51) Int. Cl. H04L 9/32

(52) U.S. Cl. 726/28

(57) ABSTRACT

This invention relates to a process for an individual (10) to access multimedia contents (CM) available on a network (12) comprising the following steps:
the individual (10) procures at least one value unit (UV) from a distributor (11);
when the individual makes a connection to this network (12), he exchanges this value unit against access to a determined multimedia content (CM).

This invention also relates to a value unit support that can be used in such a process.

### CROSS REFERENCE TO RELATED APPLICATION

This application is a divisional and claims the benefit of priority under 35 U.S.C. § 120 from U.S. application Ser. No. 10/258,609, filed Nov. 5, 2002, which claims priority to PCT National Stage Application No. PCT/FR01/01464 filed May 15, 2001 and claims the benefit of priority under 35 U.S.C. § 119 of France Patent Application No. 00/06206, filed on May 16, 2000. The entire contents of these applications are incorporated herein by reference.

### DESCRIPTION

1. Technical Domain

This invention relates to a process for access to multimedia contents available on a data network, and a value unit support that can be used in such a process.

2. State of Prior Art

The generalization of wide band data networks (cable, satellite, etc.) makes it possible to envisage the broadcasting of voluminous multimedia contents to an individual or within a company; a multimedia content represents any assembly that can be put in digital form, such as sound, image, video, software, etc.

A user who wants to access multimedia contents now available on a data network, must have an account from which the amount of any purchase can be withdrawn.

Existing technologies enable online processing of all steps in the process for marketing multimedia contents. But the development of electronic shopping appears to be hindered by poor acceptance of online payment.

Furthermore, these online purchase mechanisms that are based on the use of an account come against the following difficulties:
it is impossible to make anonymous purchases;
there is a non-negligible risk of pirating by substitution of the said account reference.

The purpose of the invention is a process to access multimedia contents (audio, image, video, software, etc.) available on data networks (Internet, cable, satellite, DAB (Digital Audio Broadcasting) or xDSL (Digital Subscriber line, or a technology with which telephone calls and high speed data can be transferred on a telephone line), that could replace existing technologies.

The purpose of the invention is a value unit support that can be used in such a process.

### PRESENTATION OF THE INVENTION

This invention relates to a process for an individual to access multimedia contents available on a data network, characterized in that it comprises the following steps:
the individual procures at least one value unit from a distributor, comprising:
   a private secret code concealed by a device that can be revealed, that provides proof that fees have been paid,
   at least one list of product codes that can be seen by every one, each product code being used to identify a multimedia content,
   a limiting validity date,
when a connection is made to this network, the individual exchanges this value unit against access to a determined multimedia content.

Advantageously, the said process is such that:
the multimedia content is only issued after the certifying organization operating on the data network has checked the validity of the value unit,
when the multimedia content has been delivered, this certifying organization invalidates the value unit.

A value unit accesses a determined list of multimedia contents.

In one advantageous embodiment, the codes and limiting validity date are printed on the support. The secret code is concealed, for example by a scratch-off ink or a label to be removed.

The secret code may be an alphanumeric code. Product codes may be alphanumeric codes or barcodes.

In one embodiment, the process according to the invention comprises the following steps:
lists of elements are created in a database, each element being composed of the combination of the secret code+limiting validity date of the secret code+list of product codes.
when a product is requested, and if the product code is valid and if the secret code is also valid, a check is made in the base to see if the secret code is actually associated with the product code, a check is made that the validity date has not expired and an order is made to release the product.
when the product has been delivered, the element considered is deleted from the database.

In another embodiment, the process according to the invention includes the following steps:
a list of elements is created in a database, each composed of a combination of the secret code+the number of purchase units still available+limiting validity date of the secret code+list of product codes, a number of purchase units necessary being associated with each product code.
when a product is requested, if the product code is valid and if the secret code is also valid, a check is made in the base to ensure that the secret code is actually associated with the product code. It is checked that the validity date has not expired, that the number of purchase units still available is greater than the number of purchase units necessary for the requested product, and the order to deliver the product is given.
when the product has been delivered, the number of purchase units still available is reduced by the number of purchase units necessary for the requested product, in the value unit of the database. When the number of available units becomes zero, the value unit is deleted from the base.

In another embodiment, secret codes are created, and instead of being destroyed after all fees have been depleted, they are simply invalidated for possible future reuse.

In another embodiment, a promotion dynamic can be created with special product codes with a negative or zero number of purchase units.

In another embodiment, the process according to the invention comprises the following steps:
during the first request for multimedia contents, the database marks the choice of a product code in the value unit.

When the credit is depleted, the value unit is not deleted from the base, but it is locked. The user can then access only the products for which the product codes are marked.

The invention also relates to a physical support for value units to enable an individual to access multimedia contents available on a data network, characterized in that it comprises:
a private secret code concealed by a device that can be revealed, that provides proof of payment of the fees,
at least one list of public product codes visible to everyone, each product code enabling identification of a multimedia product,
a limiting validity date.

In one embodiment, the codes and the validity date are printed on this support. The secret code may be concealed by ink to be scratched off or a label to be removed.

The secret code may be an alphanumeric code. The product codes may be alphanumeric codes or barcodes. A batch number may be integrated in the code header.

In another embodiment, the support is an electronic chip.

### BRIEF DESCRIPTION OF THE DRAWINGS

FIG. 1 illustrates the first step of the process according to the invention,

FIG. 2 illustrates the second step of the process according to the invention,

FIG. 3 illustrates an example embodiment of the process according to the invention,

FIG. 4 illustrates an example of a value unit support.

### Detailed presentation of embodiments

The process according to the invention is a process for access to multimedia contents available on a data network, which is not based on the use of a payment account. The individual procures an access right called a “value unit” UV that is exchanged online against the multimedia contents CM, for example by purchasing it in the shop. Therefore, he does not purchase a multimedia contents directly online.

As shown in FIG. 1, in a first step the individual 10 procures a value unit from a distributor 11, in the conventional shopping circuit using payment means MP of his choice (cash, check, credit card).

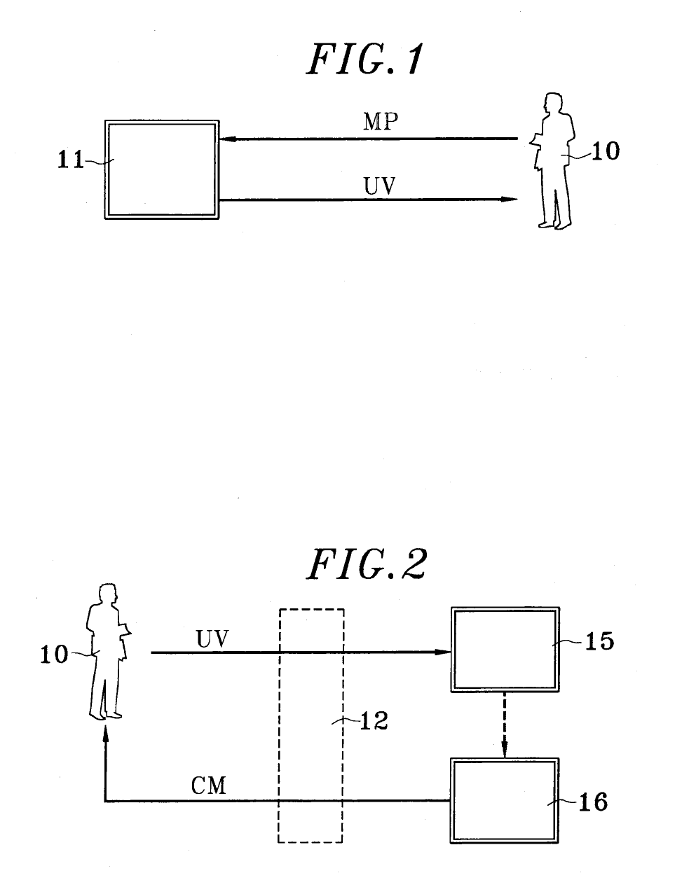

In a second step illustrated in FIG. 2, when connecting to a network 12, the individual 10 exchanges the value unit UV against access to the multimedia content CM (for example by downloading). The value unit UV provides proof that the individual has paid the distributor the right to access the multimedia content. FIG. 2 also shows the distributor 15 and the supplier 16 of the multimedia content CM.

Each value unit UV is used to access a determined list of multimedia contents CM. Therefore these value units do not form virtual money.

The Value Unit

As shown in FIG. 4, a value unit UV may for example be physically composed of a printable support 20 (magazine, newspaper, plastic card, smart card, etc.) on which the following information is printed:
a secret code 21, for example an alphanumeric code that is concealed by a device that can be removed (scratch-off ink, label to be removed, etc.). This secret code proves that the fees have been paid. It is generated from an algorithm that must remain secret and that is specific to a certifier. It is a private code. It must only be used once. It is concealed to prevent any dispute.
One or several lists of product codes 22, alphanumeric or other (barcodes, etc.) visible to every one. A product code is used to identify a multimedia product. It is generated from an algorithm specific to the product publisher. This code is public. It can be printed in plain text on the support.
A limiting validity date 23.

The process according to the invention may be used in two modes:
“Pull” mode in which the information transferred between two individuals passes from the individual who is looking for the information to the individual who has the information.

In a first example embodiment, an individual visits a disk vendor to buy a disk. Unfortunately, the disk vendor does not have the disk in the shop. The disk vendor then prints the jacket of the searched disk on which a value unit is also printed. The buyer pays and leaves with this jacket. When he gets home, he reveals the secret code part of the value unit, enters the code of the disk and the secret code on a terminal connected to the Internet network, and the terminal automatically downloads the music in exchange for the value unit, so that it can be recorded on an engraver or a disk recorder.

In a second example embodiment, an individual purchases a value unit in a newspaper shop so that he can watch a football match on his television. He hasn't yet decided what match he will watch. He pays for this value unit with a payment mode of his choice. When a match in which he is interested is broadcast encrypted on a pay television channel, he enters the match code and the previously revealed secret code of the value unit on the remote control of his television decoder, to be able to view the match decoded.
“Push” mode in which the information transferred between two individuals passes from the individual who has the information to the individual who is looking for it.

In one example embodiment, an individual takes out a subscription with an organization. This subscription is charged for and the organization debits the price of the subscription every month from the bank account of this individual. In return, the individual receives a monthly magazine on which a value unit is printed and which offers multimedia contents such as electronic books, software, music. Each proposed content is identified by a product code. The individual reveals the secret code part of the value unit, connects to the organization Internet's site and enters the code(s) of the product(s) that he wants to download in replacement for the secret code. In this example, the value unit is paid by the cost of the subscription.

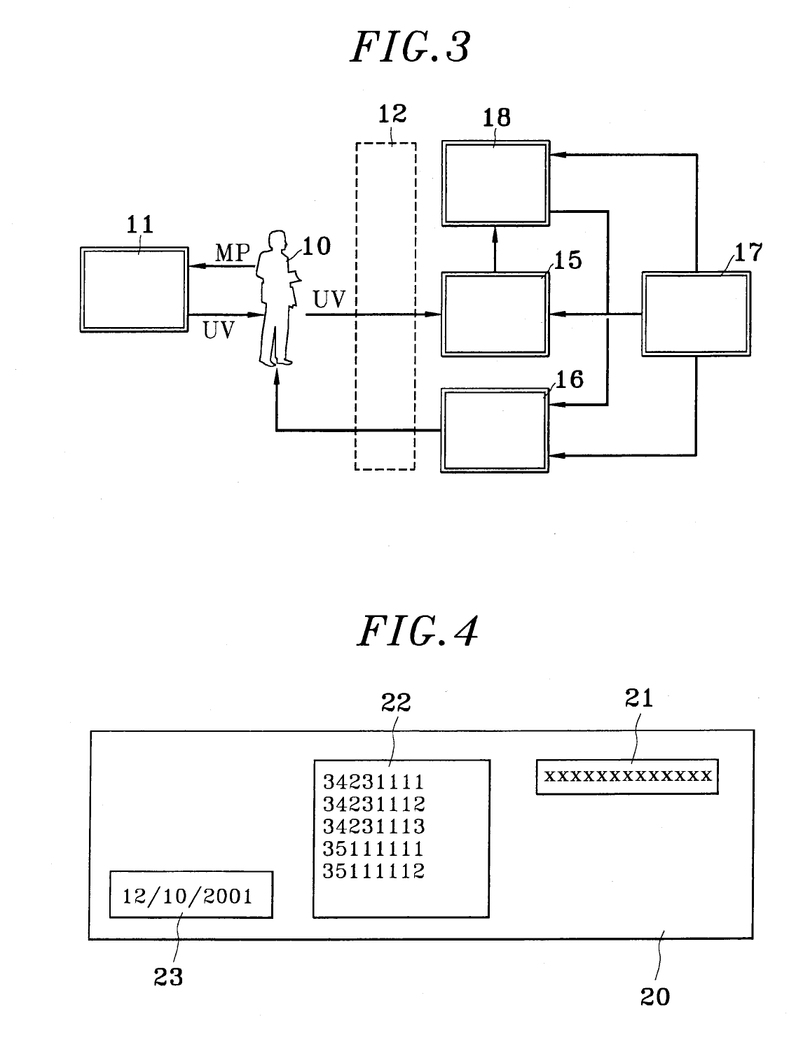

The following players are involved in the process according to the invention, as illustrated in FIG. 3:

The Publisher 17

The publisher 17 of multimedia contents is the person or legal entity who holds the rights to these contents:
he assigns a product code to the multimedia contents,
he mandates a certifier 18 so that he can correctly manage the rights,
he mandates a supplier 16 so that he can accommodate the multimedia contents on the networks,
he negotiates how to integrate his multimedia contents in the offers of distributors 15.

The Distributor 15

The distributor 15:
he negotiates proposed contents to create commercial assemblies or packages. Each package, that is a group of elements that are not necessarily homogeneous, is composed of a list of at least one product code,
he processes or subcontracts the distribution of physical supports of value units UV in the shops (“PULL” mode) or by mail (“PUSH” mode),
he collects requests for recuperation of the multimedia content on the network 12. He checks each product code and transmits the request to the certifier 18.

The Certifier 18

The certifier 18 is an organization independent of editors 17 and distributors 15.
He creates a list of value units UV for each “package” requested by the distributor 15. Each element of a list is composed of the combination of a secret code, a limiting date for the validity of the secret code and a list of product codes accessible with this secret code.
He collects usage requests for value units UV issued by customers through distributors 15. He checks each unit value UV by checking that:
1) the secret code is valid;
2) the validity date of the value unit has not expired;
3) the product code actually belongs to a list of product codes accessible with the secret code.

If the value unit is valid and the check is positive, he orders the supplier 16 to transfer the multimedia contents corresponding to it to the customer.
When he receives the acknowledgement that the content has been transferred by the supplier 16, he records the consumption of the value unit. He invalidates the value unit for a single value unit corresponding to a single usage.

The Supplier 16

A supplier 16 on each network 12 must be located as close as possible to the user 10, to provide him with voluminous multimedia contents with a good service quality. The supplier 16 is such that:
He accommodates multimedia contents and guarantees complete availability of these contents.
Following an order by the certifier 18, he transfers the requested multimedia contents to the customer 10.
He makes sure that the transfer is working correctly and informs the certifier 18.

The flexibility of the process according to the invention enables a number of possible contractual relations. Thus, to achieve a good separation of responsibilities, the distributor 15 may be the organization that mandates the supplier 16 and the certifier 18.

The following mechanisms are used for management of the value unit:

Basic Mechanism

Only the basic mechanism for management of the value unit has been mentioned so far. This is the case in which the market value for the value unit is equal to the value of each of the proposed products. The user must choose one and only one of the products in the products list. The value unit can be used once only. Thus, operation is as follows:
1) In a database, lists of elements are created, each item in the list being composed of a combination of the secret code and the limiting validity date of the secret code+list of product codes.
2) When a product is requested, and if the product code is valid and if the secret code is also valid, a check is made in the base that the secret code is actually associated with the product code considered. It is then checked that the limiting validity date has not expired and delivery of the product is ordered.
3) When the product has been delivered, the corresponding element is deleted from the database. This deletion prohibits any reuse of the value unit.

Weighting Mechanism

In some cases, the user procures a value unit for which the market value is greater than for each of the products. This value unit can then be used to make several purchases and therefore must not be eliminated after use. Furthermore, the products of the value unit do not necessarily have the same market value. The mechanism is then more complex:
1) Lists of elements are created in a database, each item being composed of a combination of the secret code+number of purchase units still available+limiting validity date of the secret code+list of product codes. A number of necessary purchase units is associated with each product code.
2) When a product request is made, if the product code is valid and if the secret code is also valid, it is checked in the base that the secret code is actually associated with the product code. It is then checked that the limiting validity date has not been exceeded, that the number of purchase units still available is greater than the number of purchase units necessary for the requested product, and delivery of the product is ordered.
3) When the product has been delivered, the number of purchase units still available is reduced by the number of purchase units necessary for the requested product, in the value unit in the database. When the number of available units becomes zero, the value unit is deleted from the database.

### “Marketing Effect” Mechanism

Secret codes are then used that are simply invalidated after rights have been depleted, and are not destroyed. These codes may subsequently be reused, particularly for promotion purposes. A distributor can thus offer products on promotion to previous purchasers who must supply an old proof of purchase. Each of these secret codes is then recombined with a new number of purchase units still available, with a new limiting validity date and with new lists of product codes.

Promotions can be created with special product codes, for which the number of purchase units is zero or negative. An issue of a product with a negative number of purchase units is “remunerating” since it increments the number of purchase units still available associated with the secret code.

### Permanent Access Mechanism

Purchase of multimedia contents in this case is not motivated by the desire to own the multimedia contents, but simply by the desire to access it at any time. The user purchases a right for permanent access to the multimedia contents that avoids the need for him to store the multimedia contents at his own home. The process according to the invention can be used to create value units that satisfy this need:
When the first request for a multimedia content is made, the database marks the choice of this product code in the value unit.
When the rights are depleted, the value unit is locked, but it is not deleted from the base. Subsequently, the user can simply access products for which the product codes are marked.

The weighting mechanism may be applied on this permanent access mechanism.

### Variant Embodiments

The process according to the invention is protected against pirating by dynamic management of combinations between the secret code+product codes. However, it is possible to integrate a batch number into the product code header or the secret code to invalidate batches of value units that have been stolen.

It is easy and very economic to print codes on the physical support. But it is also possible to replace printing codes by integrating them into an electronic chip attached to a support.

### Example Embodiment

One example embodiment illustrated in FIG. 3 includes the following steps:
1) a music publisher 17 mandates a music certifier 18,
2) the music publisher comes to an agreement with a supplier 16 of the multimedia contents who is authorized to hold the multimedia contents to enable selective transfer to a customer 10,
3) the music publisher 17 comes to an agreement with a distributor 15 so that he can sell music titles to customers 10. To achieve this, the distributor 15 enables disk shops to print jackets with value units already defined by the certifier 18,
4) after purchasing a jacket, the customer 10 reveals the secret code and connects to the site of the distributor 15 to retrieve the music on the disk by supplying the disk identifier and the secret code. The distributor 15 checks the code of the disk,
5) the distributor 15 asks the certifier 18 to check the validity of the secret code, its limiting validity date and that it is correctly associated with the code of the disk. If the reply is correct, this certifying organization 18 authorizes the multimedia contents supplier 16 to deliver the music to the customer 10.
6) The supplier 16 informs the certifier 18 that the delivery has been successfully completed.
7) The certifier 18 deletes the value unit used from the base.

What is claimed is:

1. A method of accessing multimedia contents via a data network comprising:
retrieving at least one product code from a physical recording medium, each product code identifying a multimedia content,
retrieving a secret code associated to said at least one product code from the physical recording medium,
retrieving a limiting validity date of said secret code from the physical recording medium,
requesting a multimedia content by transmitting over the network said secret code and the product code identifying the requested multimedia content,
wherein access to the requested at least one multimedia content is authorized if the limiting validity date is not expired.

2. The method according to claim 1 wherein access to the requested at least one multimedia content is authorized when the transmitted secret code and product code are valid.

3. The method according to claim 2 wherein said secret code becomes invalid once multimedia content access rights have been depleted.

4. A method of providing access to multimedia contents available via a data network, comprising
receiving a request for a multimedia content, a secret code and a product code identifying the requested multimedia content,
checking that the secret code is associated with the transmitted product code and that a limiting validity date of said secret code has not yet expired,
authorizing access to the requested at least one multimedia content in case said checking is successful.

5. The method according to claim 4 further comprising:
checking that the received secret code and product code are valid.

6. The method according to claim 5 wherein said secret code becomes invalid once multimedia content access rights have been depleted.
